(19) United States
(12) Patent Application Publication
(10) Pub. No.: US 2015/0028137 A1
(43) Pub. Date: Jan. 29, 2015

(54) TIGHTLY EXTRUSION-COATED COMPONENT AND METHOD FOR PRODUCING SUCH A COMPONENT

(71) Applicant: ROBERT BOSCH GMBH, Stuttgart (DE)

(72) Inventor: Ralf Kromer, Vaihingen (DE)

(73) Assignee: Robert Bosch GmbH, Stuttgart (DE)

(21) Appl. No.: 14/386,144

(22) PCT Filed: Feb. 18, 2013
(86) PCT No.: PCT/EP2013/053209

§ 371 Date: Sep. 18, 2014

(30) Foreign Application Priority Data
Mar. 19, 2012 (DE) 10 2012 204 305.5

(51) Int. Cl. F02M 61/08; B32B 1/08; B32B 7/12; B32B 37/15; B32B 15/08

(52) U.S. Cl. CPC F02M 61/08; B32B 37/153; B32B 15/08; B32B 7/12; B32B 1/08; B32B 2250/03; B32B 2255/06; B32B 2305/34; B32B 2307/30; B32B 2581/00; B32B 2605/00
USPC 239/584; 156/244.11; 428/35.9

(57) ABSTRACT

A component which includes a base part, a sealing element, an insert element, and an extrusion coat which extends at least partially around the insert element and at least partially around the base part, the insert element being disposed between the extrusion coat and sealing element.

### FIELD

The present invention relates to a component which is extrusion-coated by a further material. In addition, the present invention relates to a method for producing an extrusion-coated component, and to a fuel injection device for an internal combustion engine, which includes an extrusion-coated component according to the present invention.

### BACKGROUND INFORMATION

Metallic base parts extrusion-coated by a plastic material, in particular, are conventional. However, the anchoring of the extrusion coat on the base part is often insufficient because of the different expansion coefficients of base part and extrusion coat. Micro gaps therefore appear, into which liquid or gaseous media may penetrate, aided by the capillary effect. This lack of tightness can therefore lead to undesired corrosion manifestations. In addition, endeavors for improving the tightness between base part and extrusion coat are conventional. A labyrinth seal, for example, may be used for such a purpose, in that one or more recesses is/are introduced in the base part, which are filled by the extrusion-coated plastic during the extrusion process. Nevertheless, this technique, too, has shown to have an insufficient sealing effect.

However, especially when components that are subject to frequent and large temperature fluctuations are involved, it is desirable to have the extrusion coat rest tightly against the base part.

### SUMMARY

An example component of the present invention includes a base part on which an insert element has been secured. A sealing element is placed between the base part and insert element. The component furthermore includes an extrusion coat, which extends at least partially around the insert element and at least partially around the base part. The sealing element is preferably designed in such a way that it remains in contact with the base part and insert part at all times despite the different coefficients of expansion in response to temperature fluctuations. This allows better sealing between the extrusion coat and the base part. As a result, the component of the present invention provides a tight extrusion coat, for which the tightness can be ensured even in the presence of changing environmental influences.

The sealing element is preferably fixed in place within a space, preferably an annular space, which is encapsulated from the extrusion coat. The extrusion coat is therefore unable to reach the sealing element and to damage it. It is furthermore ensured that the sealing element is freely able to deform elastically in response to a change in the environmental influences. This makes it possible to ensure sufficient tightness. The space is preferably an annular space.

Especially preferably, the space for the sealing element is formed by the insert element and the base element. For example, this may be realized by a cup-shaped or a generally cylindrical insert element, which is secured on the base part, so that a surface of the insert element covers the base part. In the same way, the space may be formed by two angled surfaces of the base part and by two angled surfaces of the insert element. All of these options have the advantage of allowing a very easy and cost-effective production both of the base part and the insert element.

As an alternative, the insert element is preferably developed in two parts and includes a first part and a second part. Consequently, the space for the sealing element is preferably formed by at least one surface of the base part, the first part and the second part of the insert element. Both the first and the second part of the insert element are in contact with a surface of the base part. Since the insert element consists of two parts, the base part may have more varied forms than was the case in the first alternative.

As another alternative, the base part preferably has a recess, which is covered by the insert element. The space for the sealing element is thus created in this manner as well. This variant allows a reliable encapsulation of the space for the sealing element from the environment while offering a low-cost production.

In one advantageous specific embodiment of the present invention, the insert element and/or the base part is/are completely extrusion-coated. A complete extrusion coating of the insert element is advantageous for a reliable encapsulation of the space for the sealing element. A complete extrusion coating of the base part allows comprehensive protection of the base part from external influences.

The insert element preferably has a fusion region, which is fused to the extrusion coat. This fusion region may include a subregion or also the entire insert element. The fusing ensures that the extrusion coat and the insert element are firmly and reliably interconnected and are no longer able to separate. In this way it is possible to ensure the encapsulation of the space for the sealing element.

In a preferred manner, it is furthermore provided that the base part is made of a metallic material and/or that the insert part is made of plastic and/or that the extrusion coat is made of plastic. In particular, it is preferred that the insert element and the extrusion coat are produced from the same material. This eliminates different expansion behaviors of extrusion coat and insert element.

In addition, the present invention relates to a method which includes the following steps: First, a base part, a sealing element and an insert element must be provided. The sealing element and the insert part are then placed on a surface of the base part, in such a way that the sealing element is situated within a space between the base element and insert element. The sealing element is preferably situated within a space between the base element and insert element, which space is encapsulated from the environment. This ensures that no molten mass is able to penetrate the space of the sealing element during the final, at least partial extrusion coating of the insert element and base element. The sealing element can therefore elastically deform to a sufficient degree, so that it is able to maintain its sealing effect even under varying temperature influences.

The method is preferably implemented in that a fusion region of the insert element is fused to the extrusion coat during the step in which the base part and insert element are extrusion-coated. As an alternative or in addition, the insert element and the extrusion coat may also be fused following the extrusion coating step, once the extrusion coat has cured. The plastic welding method, in particular, may be used for this purpose. This step has the advantage that the extrusion coat and the insert element form a unit, so that they are unable to detach from each other. This ensures the tightness between insert element and extrusion coat.

Moreover, the present invention relates to a fuel injection system for an internal combustion engine. The fuel injection device includes a component according to the present invention, as described above. The component of the present invention is advantageously used in the fuel injection device in areas where fuel is carried, since a component provided with an extrusion coat is required there, the extrusion coat always having to rest tightly against the base part. The component is exposed to great temperature fluctuations, which must not impair the tightness between base part and extrusion coat, however.

### BRIEF DESCRIPTION OF THE DRAWINGS

Exemplary embodiments of the present invention are described in detail below with reference to the figures.

FIG. 1 shows a sectional view of a component according to a first exemplary embodiment of the present invention.

FIG. 2 shows a sectional view of the component according to a second preferred exemplary embodiment of the present invention.

FIG. 3 shows a sectional view of the component according to a third preferred exemplary embodiment of the present invention.

FIG. 4 shows a schematic view of a fuel injector, which includes a component according to one of the preferred specific embodiments.

### DETAILED DESCRIPTION OF EXAMPLE EMBODIMENTS

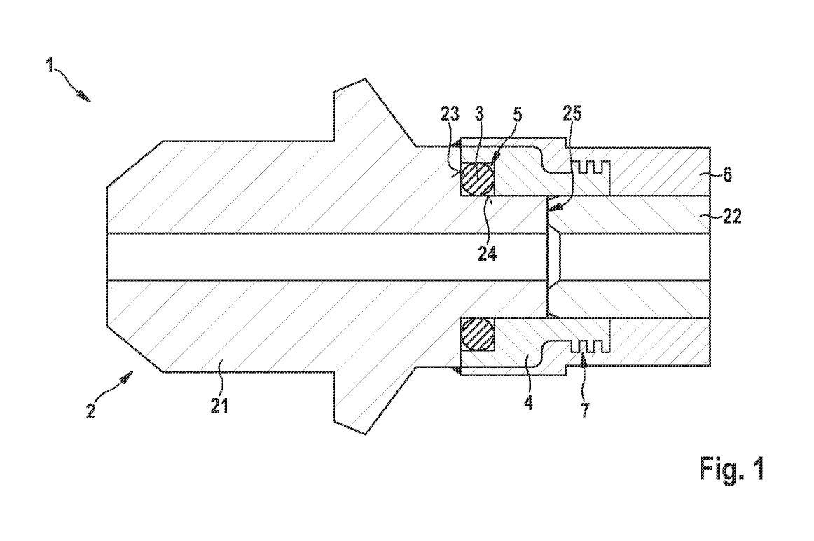

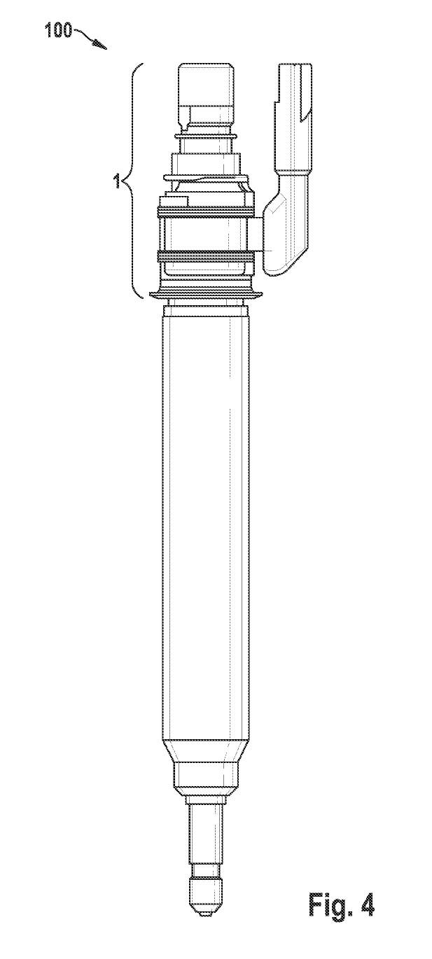

FIG. 1 shows component 1 in accordance with the present invention in a sectional view according to a first specific embodiment. Component 1 is preferably used in a fuel injector, as shown in FIG. 4. The component includes a base part 2 which is provided with an extrusion coat 6. The base part is composed of two parts, a first subregion 21 and a second subregion 22. A sealing element 3 is used to ensure the tightness between extrusion coat 6 and base part 2. Sealing element 3 is situated within a space 5, which is formed by surfaces of base part 2 and by surfaces of an insert element 4.

In this specific embodiment, base part 2 has two surfaces 23, 24 situated perpendicular to each other, which form the delimitation for space 5 on the one hand, and on which insert element 4 is resting on the other. In this manner space 5 is completely encapsulated from the environment. Depending on the environmental conditions, sealing element 3 is therefore freely able to elastically deform within space 5. In this exemplary embodiment, sealing element 3 is an O-ring and has a circular cross-section. Space 4 is an annular space having a four-cornered cross-section. Sealing element 3 in particular does not completely fill up space 4, so that it is still able to elastically deform inside space 4.

Insert element 4 is completely enveloped by an extrusion coat 6, which partially covers base part 2. Sealing element 3 in conjunction with insert element 4 seals the one seam 25 between first subregion 21 and second subregion 22 of base part 2 from an environment.

In order to ensure sufficient adhesion of extrusion coat 6 on insert element 4, and in order to ensure the tightness between extrusion coat 6 and insert element 4, insert element 4 has a fusion region 7 which is developed in the form of a labyrinth. This fusion region 7 is fused to extrusion coat 6, so that extrusion coat 6 and insert element 4 at least regionally form one unit. Overall, this specific embodiment ensures increased tightness between extrusion coat 6 and base part 2 even in the presence of changing environmental influences.

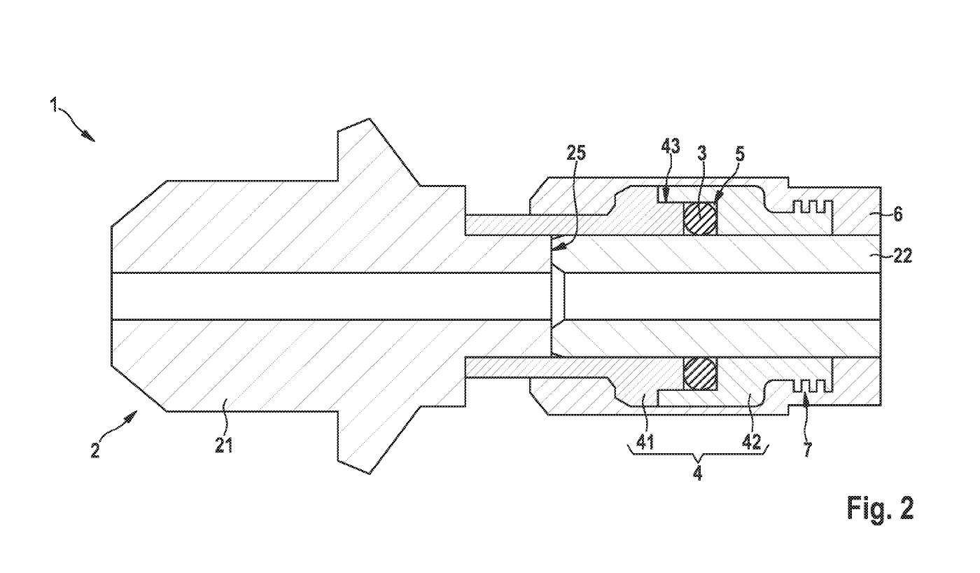

FIG. 2 shows a sectional view of component 1 according to a second specific embodiment of the present invention. Analogous to the first specific embodiment, component 1 of the second specific embodiment may likewise be used in a fuel injector 100 (see FIG. 4). Identical or functionally equivalent elements have been provided with the same reference numerals as in the previous exemplary embodiment. In contrast to the first specific embodiment, insert element 4 in the second specific embodiment is divided into two parts and made up of a first part 41 and a second part 42. As a result, space 5, in which sealing element 3 is located, is formed by different surfaces than in the first specific embodiment. Space 5 is delimited by a surface of base part 2, a surface of first insert element 41, and by two surfaces of the second part of insert element 42. In addition, both first part 41 and second part 42 rest on the surface of base part 2 that delimits space 5. In addition, second part 42 engages with a recess 43 of first part 41. Extrusion coat 6 covers second part 42 of insert part 4 completely, and first part 41 covers insert element 4 only partially.

The use of the bipartite insert element 4 reduces the demands on the design of base part 2 since it is possible to dispense with a second surface, delimiting space 5, on base part 2. Here, too, insert element 4 has a fusion region 7, which is fused to extrusion coat 6. As a result, extrusion coat 6 and insert element 4 at least regionally form a unit in the second specific embodiment of the present invention as well.

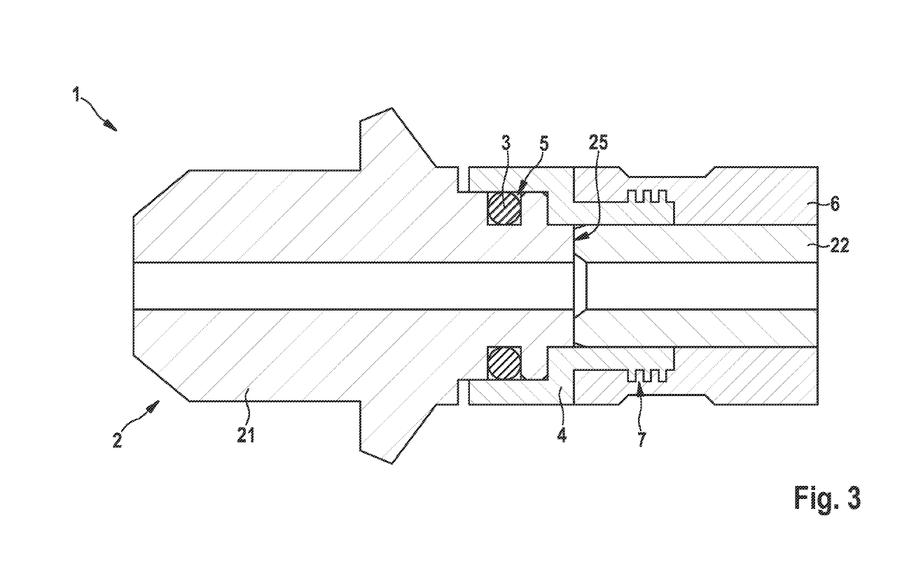

FIG. 3 shows component 1, which may be used in a fuel injector 100 as shown in FIG. 4, according to a third specific embodiment of the present invention, in a sectional view. Same or functionally equivalent parts are once again designated by the same reference numerals as in the previous exemplary embodiments. In this specific embodiment, space 5 for sealing element 3 is predominantly formed by a recess of base part 2. The recess is preferably large enough to completely accommodate sealing element 3. In addition, space 5 is formed by insert element 4, which covers the recess of base part 2. In this specific embodiment, only partial extrusion coating of insert element 4 is required to ensure sufficient encapsulation of space 5. Extrusion coat 6 therefore includes only a portion of insert element 4. Analogous to the previously mentioned specific embodiments, insert element 4 has a fusion region, which is fused to extrusion coat 6. One advantage of this specific embodiment is that no molten mass is able to penetrate space 5, for construction-related reasons. The encapsulation of space 5 is therefore obtained at very low production expense.

1-11. (canceled)

12. A component, comprising:
a base part;
a sealing element;
an insert element; and
an extrusion coat which extends at least partially around the insert element and at least partially around the base part, the insert element being situated between the extrusion coat and sealing element.

13. The component as recited in claim 12, wherein the sealing element is disposed within a space which is encapsulated from the extrusion coat.

14. The component as recited in claim 13, wherein a space for the sealing element is formed by the insert element and the base element.

15. The component as recited in claim 13, wherein the insert element includes a first part and a second part, and the space for the sealing element is formed by the first part and the second part of the insert element and the base element.

16. The component as recited in claim 13, wherein the space for the sealing element is formed by a recess of the base element which recess is covered by the insert element.

17. The component as recited in claim 12, wherein at least one of the insert element and the base element is completely extrusion-coated.

18. The component as recited in claim 12, wherein the insert element has a fusion region which is fused to the extrusion coat.

19. The component as recited in claim 12, wherein at least one of: i) the base part is made of a metallic material, ii) the insert part is made of plastic, and iii) the extrusion coat is made of plastic.

20. A method for extrusion-coating a component, comprising:
providing a base part, a sealing element and an insert element;
placing the sealing element within a space between the base element and insert element; and
extrusion-coating the insert element and the base element at least partially.

21. The method as recited in claim 20, wherein at least one of: i) during the extrusion-coating, a fusion region of the insert element is fused with the extrusion coat, and ii) the insert element and the extrusion coat are fused following the extrusion-coating step, using plastic welding.

22. A fuel injection device for an internal combustion engine, including a component including a base part, a sealing element, an insert element, and an extrusion coat which extends at least partially around the insert element and at least partially around the base part, the insert element being situated between the extrusion coat and sealing element.
